(19) United States
(12) Patent Application Publication
(10) Pub. No.: US 2014/0319856 A1
(43) Pub. Date: Oct. 30, 2014

(54) ANGLED SECURITY PLATE

(71) Applicant: LARRY JOHN CAHOON, LA MIRADA, CA (US)

(72) Inventor: LARRY JOHN CAHOON, LA MIRADA, CA (US)

(21) Appl. No.: 14/082,366

(22) Filed: Nov. 18, 2013

Related U.S. Application Data
(60) Provisional application No. 61/817,725, filed on Apr. 30, 2013.

(51) Int. Cl. E05B 15/02

(52) U.S. Cl. CPC E05B 15/0205
USPC 292/341.14; 29/426.2

(57) ABSTRACT

An angled security plate is configured to increase tensile strength of a door jamb attached to a door frame and prevent an unwanted entry through a door. The angled security plate includes a first leg connected to a second leg at a right angle. A deadbolt tab is connected to the second leg creating a deadbolt channel. Mounting screws are driven through the first leg and connecting the angled security plate to the door frame. Strike mounting screws are driven through the second leg and connecting the second leg to the door jamb and an upper strike which can accommodate a deadbolt. The deadbolt tab increases the tensile strength of the door jamb by requiring an intruder to break through both the door jamb and the door frame to effect the unwanted entry.

### RELATED APPLICATION

This application claims priority to provisional patent application U.S. Ser. No. 61/817,725 filed on Apr. 30, 2013, the entire contents of which is herein incorporated by reference.

### BACKGROUND

The embodiments herein relate generally to securing doors and preventing intrusion. Prior to embodiments of the disclosed invention, : Residential, and some commercial, entry doors are usually only locked by a deadbolt which most often engages a wood frame that is vulnerable to break-ins. Embodiments of the disclosed invention resolve this problem. The prior art includes: U.S. Pat. No. 8,510,995 issued to Fulton.

Fulton teaches a deadbolt strengthening system comprising a plate inserted between a door jamb and a door frame and then affixed to the door jamb and the door frame with the fasteners around the deadbolt cavity in order to prevent breaking of the door jamb proximate the deadbolt cavity which prevents the unauthorized access inside the door. The plate contains a latch tongue configured to fit into a latch aperture, but does not fit or attach around the doors framing members, rendering it less effective than embodiments of the present invention.

### SUMMARY

An angled security plate is configured to increase tensile strength of a door jamb attached to a door frame and prevent an unwanted entry through a door. The angled security plate includes a first leg connected to a second leg at a right angle. A deadbolt tab is connected to the second leg creating a deadbolt channel. Mounting screws are driven through the first leg and connecting the angled security plate to the door frame. Strike mounting screws are driven through the second leg and connecting the second leg to the door jamb and an upper strike which can accommodate a deadbolt. The deadbolt tab increases the tensile strength of the door jamb by requiring an intruder to break through both the door jamb and the door frame to effect the unwanted entry.

A process secures a door in a door frame attached to a door jamb with an angled security plate. The process includes the following steps, not necessarily in order. First, removing an existing entry door and frame. Next, attaching the angled security plate to the door jamb; wherein the angled security plate comprises a first leg connected to a second leg at a right angle and a deadbolt tab attached to the second leg. Then, installing the door frame ensuring the door frame is level, plumb and square. After that, pushing the angled security plate against the door frame and attaching the angled security plate to the door frame. Next, carving an upper opening in order for the door jamb to accommodate the deadbolt tab. Finally, installing the door such that a deadbolt in the door fits immediately adjacent to the deadbolt tab.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of an embodiment of the invention in use, with parts broken away.

FIG. 2 is a perspective view of an embodiment of the invention with the door not shown.

FIG. 3 is an exploded perspective view.

FIG. 4 is a perspective view of an embodiment of the security plate.

FIG. 5 is a cross-sectional view taken on line 5-5 of FIG. 2.

FIG. 6 is a schematic of a process.

### DETAILED DESCRIPTION OF CERTAIN EMBODIMENTS

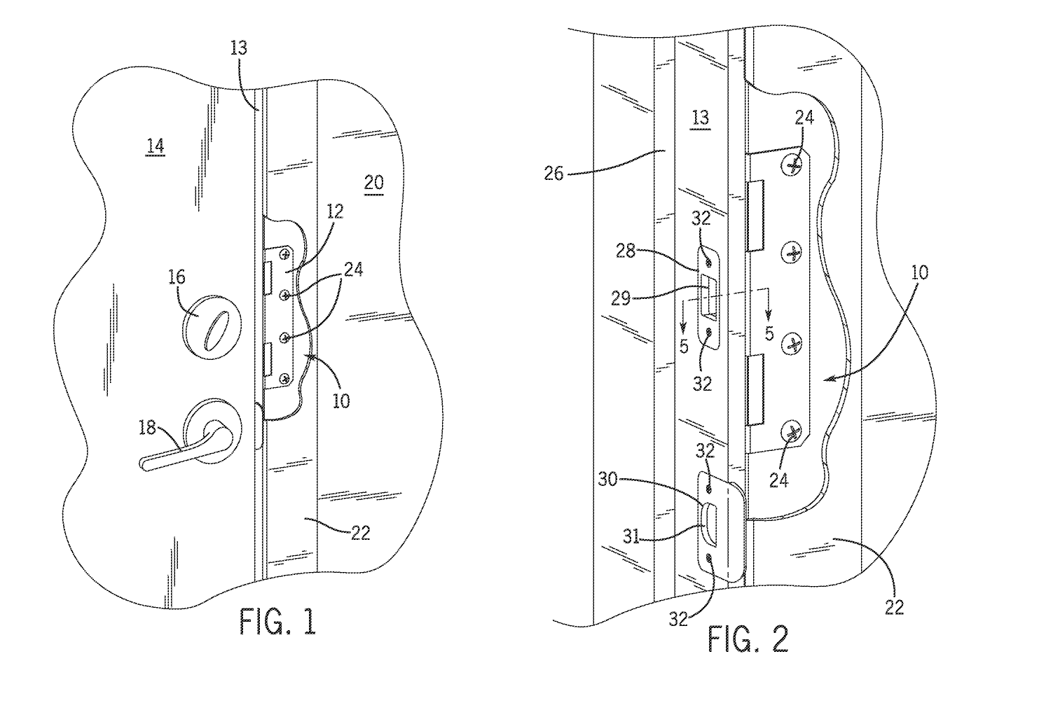

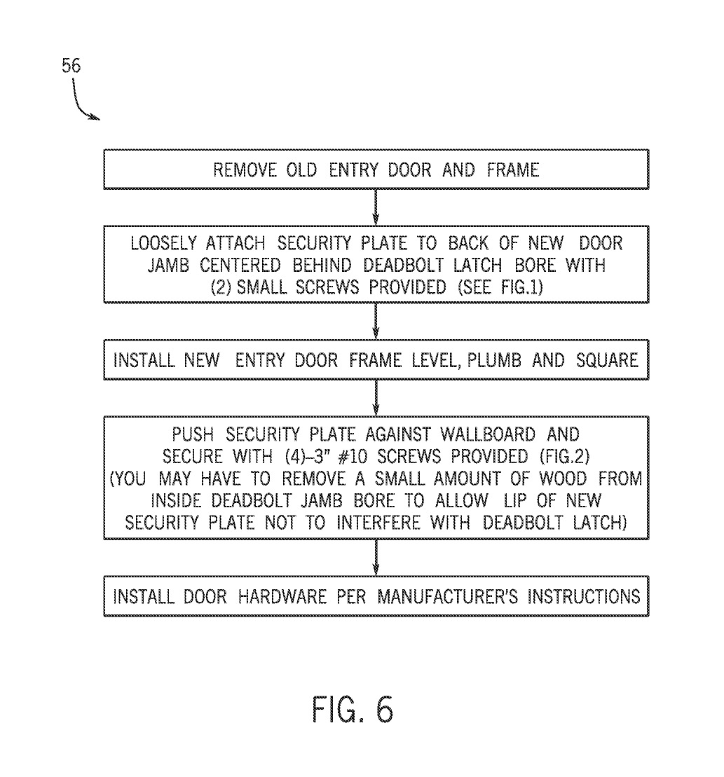

By way of example, and referring to FIG. 1 and FIG. 5, door 14 is attached to deadbolt lock 16 and latch 18. To close door 14, one simply places door 14 immediately adjacent to door jamb 13. To lock door 14, one engages deadbolt lock 16. Door jamb 13 is mechanically coupled to wall 20. Wall 20 is further attached to trim 22. Angled security plate 10 is configured to increase tensile strength of door jamb 13 attached to door frame 52 and prevent unwanted entry through door 14.

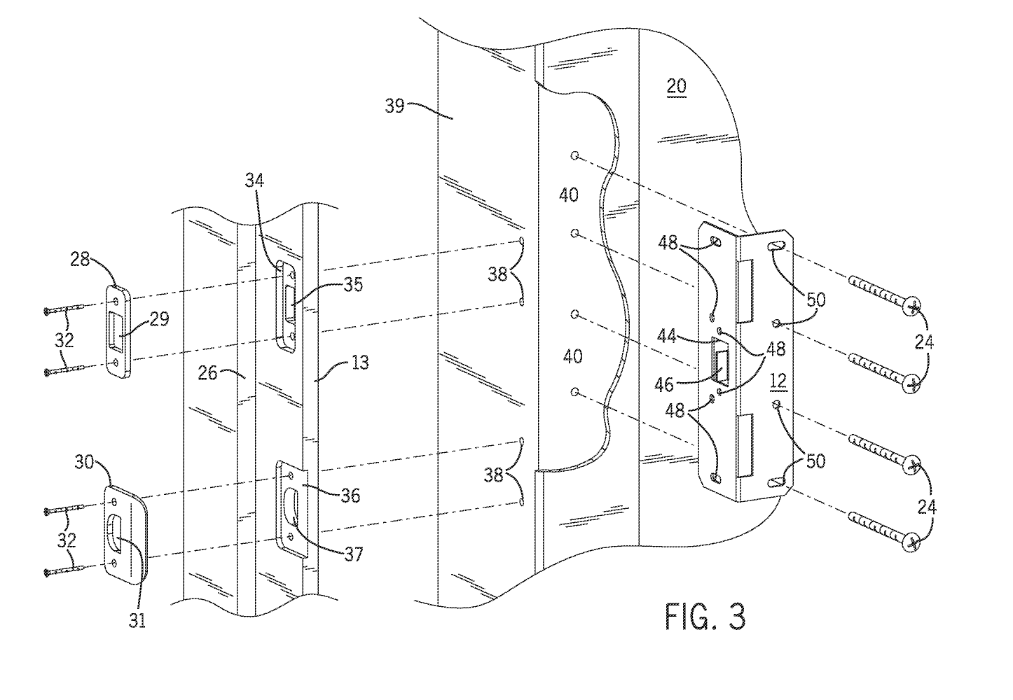

Turning to FIG. 2 and FIG. 3, door jamb 13 is mechanically coupled to stop 26. Stop 26 stops motion of door 14 in one direction. Door jamb 13 comprises upper opening 35 in door jamb 13 for upper strike 28. Upper opening 35 further comprises upper mortise 34. Upper mortise 34 is configured to accommodate upper strike 28 for deadbolt 16 through upper strike opening 29.

Similarly, lower mortise 36 is installed with lower opening 37 in jamb 13 for lower strike 30. Lower strike 30 is configured with lower strike opening 31.

Wall 20 comprises wall opening 39 which is proximate where door 14 and stop 26 are installed. As shown in FIG. 5, wall 20 further comprises framing member 52.

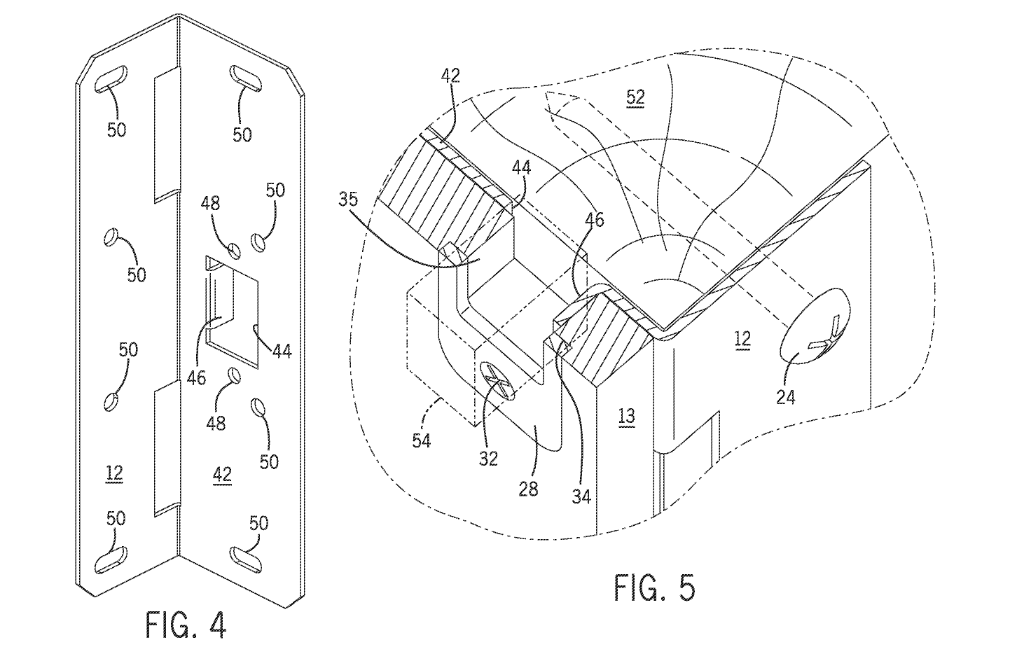

Angled security plate 10 is mechanically coupled to wall 20 behind door jamb 13 and under trim 22. Turning to FIG. 4, angled security plate 10 comprises first leg 12 attached to second leg 42 at a right angle. First leg 12 comprises first leg upper mounting slot 50, first leg upper mounting hole 50, first leg lower mounting hole 50 and first leg lower mounting slot 50. Second leg 42 comprises second leg upper mounting slot 50, second leg upper mounting hole 50, second leg lower mounting hole 50 and second leg lower mounting slot 50. Second leg 42 comprises an second leg upper strike hole 48 and a second leg lower strike hole 48.

Turning to FIG. 5, second leg 42 is mechanically coupled to deadbolt tab 46 which is attached to create strike opening 44. Deadbolt tab 46 fits partially through upper opening 35 in door jamb 13 for strike 28 which can be a deadbolt channel. Strike 28 is mechanically coupled to door jamb 13 with strike mounting screw 32. This permits passage of deadbolt 54 immediately adjacent to deadbolt tab 46. Wall 20 is shown here, more particularly, as having framing member 52 which can accommodate mounting screw 24 through first leg 12.

FIG. 6 shows process 56 for installing angled security plate 10. First, removing the existing entry door and frame. Next, attaching angled security plate 10 to door jamb 13 by inserting two strike mounting screws into through second leg 42 into door jamb 13. Then, installing door frame 52 ensuring door frame 52 is level, plumb and square. After that, pushing angled security plate 10 against door frame 52 and attaching angled security plate 10 to door frame 52 with four mounting screws 24.

Next, carving upper opening 35 in order for door jamb 13 to accommodate deadbolt tab 46. Finally, installing door 14 such that deadbolt 54 fits immediately adjacent to deadbolt tab 46.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An angled security plate, configured to increase tensile strength of a door jamb attached to a door frame and prevent an unwanted entry through a door; the angled security plate comprising:
a first leg connected to a second leg at a right angle;
a deadbolt tab connected to the second leg creating a deadbolt channel;
mounting screws, driven through the first leg and connecting the angled security plate to the door frame;
strike mounting screws, driven through the second leg and connecting the second leg to the door jamb and an upper strike which can accommodate a deadbolt;
wherein the deadbolt tab increases the tensile strength of the door jamb by requiring an intruder to break through both the door jamb and the door frame to effect the unwanted entry.

2. The angled security plate of claim 1, wherein the first leg and the second leg utilize mounting holes and mounting slots in order to accommodate the mounting screws.

3. The angled security plate of claim 1, wherein the second leg utilizes mounting holes to accommodate the strike mounting screws.

4. A process secures a door in a door frame attached to a door jamb with an angled security plate; the process comprising:
removing an existing entry door and frame;
attaching the angled security plate to the door jamb; wherein the angled security plate comprises a first leg connected to a second leg at a right angle and a deadbolt tab attached to the second leg;
installing the door frame ensuring the door frame is level, plumb and square;
pushing the angled security plate against the door frame and attaching the angled security plate to the door frame;
carving an upper opening in order for the door jamb to accommodate the deadbolt tab; and
installing the door such that a deadbolt in the door fits immediately adjacent to the deadbolt tab.

5. The process of claim 4, wherein the angled security plate is attached to the door jamb with four mounting screws.

6. The process of claim 4, wherein the angled security plate is attached to the door jamb by inserting strike mounting screws into through the second leg into the door jamb.
